(19) United States
(12) Patent Application Publication
(10) Pub. No.: US 2008/0187066 A1
(43) Pub. Date: Aug. 7, 2008

(54) Detection method and apparatus for a multi-stream MIMO

(75) Inventors: Haifeng Wang, Shanghai (CN); Jorma Lilleberg, Oulu (FI); Wei Li, Nanjing (CN); Ming Chen, Nanjing (CN); Shixin Cheng, Nanjing (CN)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 11/826,360

(22) Filed: Jul. 13, 2007

(30) Foreign Application Priority Data
Feb. 6, 2007 (FI) 20075083

(51) Int. Cl. H04L 1/02

(52) U.S. Cl. 375/267

(57) ABSTRACT

In a multiple-input multiple output (MIMO) system, high-rate data transmission is achieved by dividing the original data stream into several parallel data substreams, each of which is transmitted from a corresponding transmit antenna (spatial multiplexing) and received by multiple receive antennas. The number of spatial streams depends on the number of antennas. In a receiver, a search-tree based QR Decomposition-M (QRD-M) algorithm is used. According to the invention, multiple spatial signal streams received from a MIMO channel are pre-ordered based on modulation alphabets of said received spatial signal streams prior to performing a QRD-M detection.

### FIELD OF THE INVENTION

The present invention relates to digital communications, and particularly to detection of multiple streams in a multiple-input multiple-output (MIMO) system.

### BACKGROUND OF THE INVENTION

In the last few years wireless services have become more and more important. Likewise the demand for higher network capacity and performance has increased. Multiple-input multiple-output (MIMO) technique can provide significant performance gain on the system capacity over the traditional single-input single-output (SISO) systems. Therefore, the MIMO technique is becoming a favourite solution to support higher data rate transmission in communications. See documents [1]-[7] below. In a MIMO system, high-rate data transmission is achieved by dividing the original data stream into several parallel data substreams, each of which is transmitted from a corresponding transmitting antenna (spatial multiplexing). The number of spatial streams depends on the number of antennas so that it is the minimum of the number of the transmit antennas and the number of receive antennas. All data substreams are independent of each other and different data substreams act as interference upon reception by a plurality of receiving antennas. The receiver has the possibility to separate and equalize the multiple signal paths and data streams by using the channel properties (the channel estimate) and knowledge of the coding scheme.

[1] Yuanbin Guo, McCain, D., “Reduced QRD-M detector in MIMO-OFDM systems with partial and embedded sorting,” Global Telecommunications Conference, 2005. GLOBECOM'05. IEEE, Vol. 1, 2005.

[2] Chin W. H., “QRD based tree search data detection for MIMO communication systems,” Vehicular Technology Conference, 2005. VTC 2005-Spring.

[3] P. W. Wolniansky, G. J. Foschini, G. D. Golden and R. A. Valenzuela, “V-BLAST: An architecture for realizing very high data rates over the rich-scattering wireless channel”.

[4] Jiang Yue, Kyeong Jin Kim, G. D. Gibson and Ronald A. Iltis, “Channel estimation and data detection for MIMO-OFDM systems”.

[5] Kyeong Jin Kim, Jiang Yue, Iltis R. A., Gibson J. D., “A QRD-M/Kalman filter-based detection and channel estimation algorithm for MIMO-OFDM systems,” IEEE transactions on Wireless communications, Vol. 4, March 2005.

[6] Kawai H., Higuchi K., Maeda N., Sawahashi M., “Independent adaptive control of surviving symbol replica candidates at each stage based on minimum branch metric in QRD-MLD for OFDCM MIMO multiplexing [mobile radio],” Vehicular Technology Conference, 2004. VTC2004-Fall, Vol. 3, September 2004.

[7] Yongmei Dai; Sumei Sun; Zhongding Lei, “A Comparative Study of QRD-M Detection and Sphere Decoding for MIMO-OFDM Systems,” Personal, Indoor and Mobile Radio Communications, 2005. PIMRC 2005. IEEE 16th International Symposium on, vol.1, no.pp. 186-190, 11-14 Sep. 2005

MIMO is applicable to all kinds of wireless communication technologies. In the recent 3GGP UTRA (UMTS Terrestrial Radio Access) Releases, a WCDMA and MIMO with up to 4 transmit and 4 receive antennas can be used which means up to 4 spatial streams. Further, a TDD (time division duplex) mode and a FDD (frequency division duplex) mode are available to provide different transmission directions (downlink/uplink, forward/reverse). In the TDD mode the PARC (Per Antenna Rate Control) is used. The PARC is able to adapt the modulation and the coding rate to the quality of the channel. There are four coding schemes consisting of QPSK and 16QAM as well as FEC (Forward Error Correction) code rate ½ and ¾. In total the PARC is able to provide four data streams. The FDD mode uses a D-TxAA (Double Transmit Adaptive Array) which is based on the STTD (Space-Time Transmit Diversity) principle defined in Release 99. In D-TxAA, if four transmit antennas are employed in the transmitter, the transmit antennas are divided into two subgroups and each sub-group transmits independent data stream with TxAA (Transmit Antenna Array) operation of a pair of transmit antennas. The data rate of each sub-group can be controlled independently. The D-TxAA can be seen as twofold Transmit Diversity chain. Each chain is controlled similar to the PARC depending on the channel.

The 3GPP release 8 is also known as “Long Term Evolution” (LTE) and relate to E-UTRA (Evolved UTRA). The LTE uses orthogonal frequency-division multiplexing (OFDM) in downlink. The OFDM is one of the most competitive candidates among techniques used for high-rate data transmission in wireless environments. OFDM is a digital multi-carrier modulation scheme, which uses a number of closely spaced orthogonal sub-carriers. Each sub-carrier is modulated with a conventional modulation scheme (such as QAM) at a low symbol rate, maintaining data rates similar to conventional single-carrier modulation schemes in the same bandwidth. The orthogonality of the sub-carriers results in zero cross talk, even though they are so close that their spectra overlap. Low symbol rate helps manage time-domain spreading of the signal (such as multipath propagation) by allowing the use of a guard interval between symbols. More specifically, since low symbol rate modulation schemes (i.e. where the symbols are relatively long compared to the channel time characteristics) suffer less from intersymbol interference (ISI) caused by multipath, it is advantageous to transmit a number of low-rate streams in parallel instead of a single high-rate stream. Since the duration of each symbol is long, it is feasible to insert a guard interval between the OFDM symbols, thus eliminating the ISI. In practice, OFDM signals are generated at the transmitter using the inverse Fast Fourier transform (IFFT) algorithm which converts a frequency-domain data into time-domain data, the thereby map the data on to the orthogonal subcarriers. For example, the IFFT correlates the frequency-domain input data with its orthogonal basis functions which are sinusoidal at certain frequencies. At the receiver, the Fast Fourier transform (FFT) is used for converting the received time-domain signal into frequency domain. Ideally, the FFT output would be the original symbols that were inputted to the IFFT at the transmitter. However, in practice the FFT output values contain random non-idealities caused by the transmission channel and multipath propagation. Therefore, channel estimates may be generated for each of the subcarries, so that a detector is able to effectively detect the symbols from the received FFT output symbols and the channel estimates. MIMO can used to facilitate the detection. Thus, combination of the MIMO and the OFDM, so called MIMO-OFDM system can achieve high data rates while providing better system performance by using both antenna diversity and frequency diversity, which makes it attractive for high-data-rate wireless applications.

One challenge for practical implementation of spatial-multiplexing-based MIMO system is to design a receiver that offers a good trade-off between its complexity and its performance. The maximum likelihood signal detecting (MLSD) method can be used to achieve the best performance in MIMO communications, but its huge complexity makes it impractical for real applications. The search-tree based QR Decomposition-M (QRD-M) algorithm achieves near the MLSD-performance, while requiring comparatively low complexity. In QRD-M, the signal detecting order has great impacts on the performance and several methods have been proposed in [3] and [4] to achieve better performance based on channel impulse responses.

### DISCLOSURE OF THE INVENTION

An object of the invention is to provide a novel QRD-M based detection in a multi-stream MIMO system.

The objects of the invention are achieved by a method, a processor program, a processor-readable medium, an apparatus, a wireless terminal and a wireless base station which are characterized by what is stated in the independent claims. The preferred embodiments of the invention are disclosed in the dependent claims.

According to the invention, multiple spatial signal streams received from a multiple-input multiple output (MIMO) channel are pre-ordered multiple received spatial signal streams from a multiple-input multiple output (MIMO) channel based on modulation alphabets of said received spatial signal streams prior to performing a QR Decomposition-M detection. An improvement in the performance of QRD-M detection can be achieved without increasing the complexity of the receiver design in comparison with the conventional ones.

In embodiments of the invention, elements of a signal vector formed from said received spatial signal streams, and elements of an estimated transmission channel matrix of the MIMO channel are pre-ordered based on said modulation alphabets of said received spatial signal streams prior to performing said QR Decomposition-M detection. In an embodiment of the invention, elements of a signal vector formed from said received spatial signal streams, and elements of an estimated transmission channel matrix of the MIMO channel are pre-ordered into groups based on said modulation alphabets of said received spatial signal streams such that each of said group corresponds to different value of said modulation alphabets. In a further embodiment, A further preordering, such as a H-norm ordering and a H-inverse ordering, is performed within each group of said elements of said signal vector and said elements of said transmission channel matrix prior to performing said QR Decomposition-M detection. In an embodiment of the invention, the received spatial signal streams include 16QAM-modulated spatial signal streams having a modulation alphabet with value 16, and QPSK-modulated spatial signal streams having a modulation alphabet with value 4. In still further embodiments, the received spatial signal streams include multiple spatial signal streams from an orthogonal frequency division multiplexing (OFDM) MIMO channel or a transmit antenna array (TxAA) MIMO channel or a double transmit antenna array (D-TxAA) MIMO channel. In an embodiment of the invention, the received spatial signal streams include multiple spatial signal streams with independently variable modulation schemes, such as multiple spatial signal streams which are rate controlled by a per-antenna rate control (PARC).

### BRIEF DESCRIPTION OF THE DRAWINGS

In the following the invention will be described in greater detail by means of preferred embodiments with reference to the attached [accompanying] drawings, in which

FIG. 1 is a functional block diagram illustrating an example of a communication system employing a multi-stream MIMO with the PARC technique;

FIG. 2 is a functional block diagram illustrating an example of a transmitter employing a multi-stream MIMO with the double-TxAA (D-TxAA) technique;

FIG. 3 is a functional block diagram illustrating an example of a MIMO-OFDM system using Nₜ transmit and Nᵣ receive antennas;

FIG. 4 illustrates a 3-stage QRD-M searching example with M=2;

FIG. 5 is a flowchart illustrating the prior art H-norm signal ordering;

FIG. 6 is a flowchart illustrating an example of a pre-ordering detection according to the invention;

FIGS. 7 and 8 illustrate graphically the effect of the pre-ordering algorithm in an example embodiment applied in a 4×4 MIMO system; and

FIGS. 9, 10 and 11 are graphs which illustrate simulation results of a conventional detection and a pre-ordering detection according to two embodiments of the invention.

### DETAILED DESCRIPTION OF THE INVENTION

In the following, some examples are given of wireless multi-stream MIMO systems and receivers wherein the detection according to the present invention may be implemented. However, the invention is not intended to be restricted to these examples but the principles of the present invention can be generally applied to any wireless MIMO (multiple-input multiple-output) communications between remotely-positioned communication stations in a communication system, such as in a cellular communication system operable pursuant to a second/third/fourth generation (2G/3G/4G) communication standard, or in other types of cellular, and other, communication systems, such as WLAN (wireless local area network), WiMAX, etc. In particular, the present invention may be implemented systems pursuant to 3GPP Releases 7 and 8 for HSPDA (high speed packet data access) and LTE (long term evolution) which use a multi-stream MIMO, e.g. PARC (per-antenna rate control) or D-TxAA (Double transmit adaptive array).

Further, the principles of the present invention can be applied to one or both of the transmission directions between a mobile station or user equipment and a base transceiver station. In other words, in some embodiments the invention is applied on the downlink/forward link, that is, communication of data by the base transceiver station to the mobile station, in which the base transceiver station forms the transmitter station and the mobile station forms the receiver station. In some embodiments of the present invention the mobile station forms the transmitter station and the base transceiver station forms the receiver station. Further, in any communication system that provides for duplex communications, the communication stations operable pursuant to a communication session are capable both of sending and receiving data, and each communication station may operate as both a transmitter station and a receiver station.

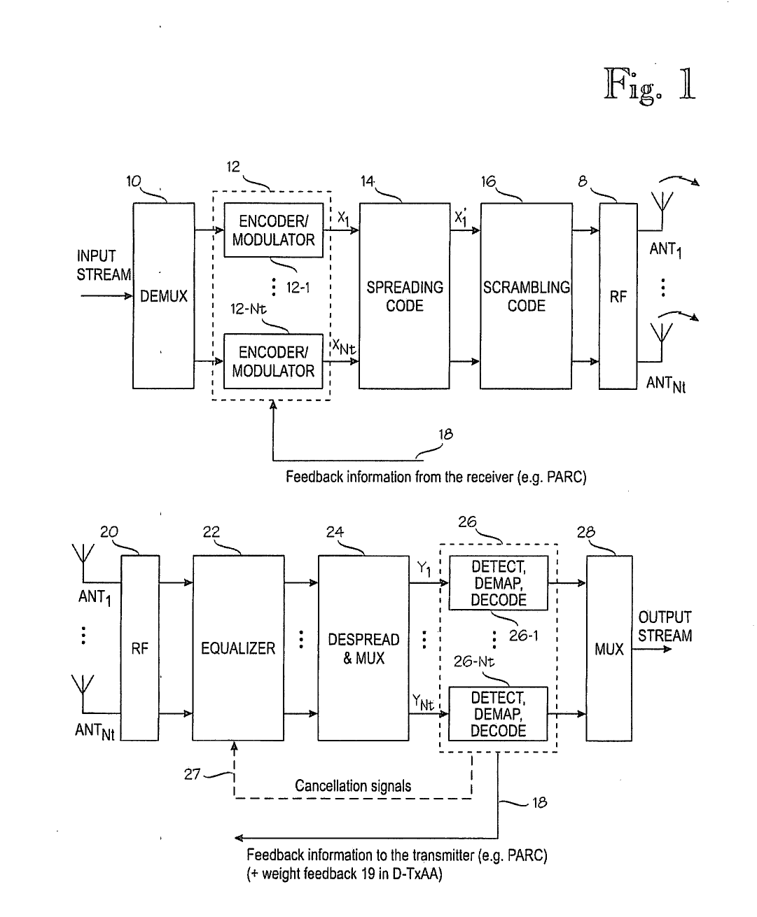

An example of a communication system employing a multi-stream MIMO with the PARC technique is shown in FIG. 1. The number of transmit antennas is Nₜ, and the number of receive antennas is Nᵣ. At the transmitter, the high-speed information stream is first demultiplexed into Nₜ substreams by a demultiplexing block 10. the substreams are inputted to a encoder/modulator bank 12 in which each of the substreams is separately encoded and modulated by a respective one of encoding and modulating blocks 12-1 . . . 12Nₜ. In modulation, the each data substream is mapped by a constellation mapper onto a stream of symbols, such as quadrature phase shift keying (QPSK) and 16-quadrature amplitude modulation (16-QAM). Each of the modulated data streams x₁ . . . x_{Nt} is separately multiplied by the same set of spreading codes in a spreading code block 14. Each modulated data stream x₁ . . . x_{Nt} results in a corresponding set of spread signals which are combined into a respective spread data stream x₁′ . . . x_{Nt}′. Each of the data streams x₁′ . . . x_{Nt}′ is separately multiplied by a common scrambling code in a scrambling code block 15, and transmitted by a RF transmitter section 8 at the same radio frequency (RF) channel through the respective one of the Nₜ transmit antennas. Because the multiple data streams are modulated in the same bandwidth using the same set of spreading codes, this technique is sometimes called “code reuse”. The data streams may preferably be transmitted from the antennas ANT₁ . . . ANT_{Nt} with equal RF power but possibly with different data rates. The data rates for each antenna are controlled in the encoder/modulator bank 12 by adaptively allocating transmit resources such as modulation order, code rate, and number of spreading codes based on feedback information 18 obtained from a receiver.

At the receiver, the signals transmitted from the Nₜ transmit antennas are received by the Nᵣ receive antennas ANT₁ . . . ANT_{Nr}. The receiver may be a weighting matrix (W) based MIMO receiver, for example. In an embodiment shown in FIG. 1, the received signals from the Nᵣ antennas are applied through a receiver RF section 20 to an equalizer 22, such as an MMSE (minimum mean square error) equalizer, which attempts to cancel various kinds of interference, such as the interference due to the multipath propagation. Interference suppression/cancellation techniques may also be employed in addition to the equalizer. In an embodiment shown in FIG. 1, feedback signals 27 reconstructed from the detected and decoded bits may be subracted from the equalizer's input signals to provide interference cancellation. After the equalization 22, each recovered transmit signal is separately despread in the despreading and multiplexing block with the same set of spreading codes as that used in the transmitter so that each recovered signal results in a corresponding set of despread signals which are multiplexed into a single received substream y₁ . . . y_{Nt}. Each received substream is applied to a respective detection/demapping/decoding block 26-1 . . . 26-Nᵣ in the detector bank 26 so that each substream signal which is detected, demapped and decoded. Thereby Nₜ decoded signals are provided, which are then collected and multiplexed to form a high-speed output data stream by a multiplexing block 28. The receiver also provides feedback information 18 to the transmitter so that the transmitter can adjust data rate at each antenna independently based on the feedback information. For example, the post-decoding SINR of each transmit antenna is estimated at the receiver and then fed back to the transmitter. Additionally, when the receiver is used in connection with a D-TxAA technique, the receiver may also provide weight vector feedback information 19 to the transmitter, as will be explained below.

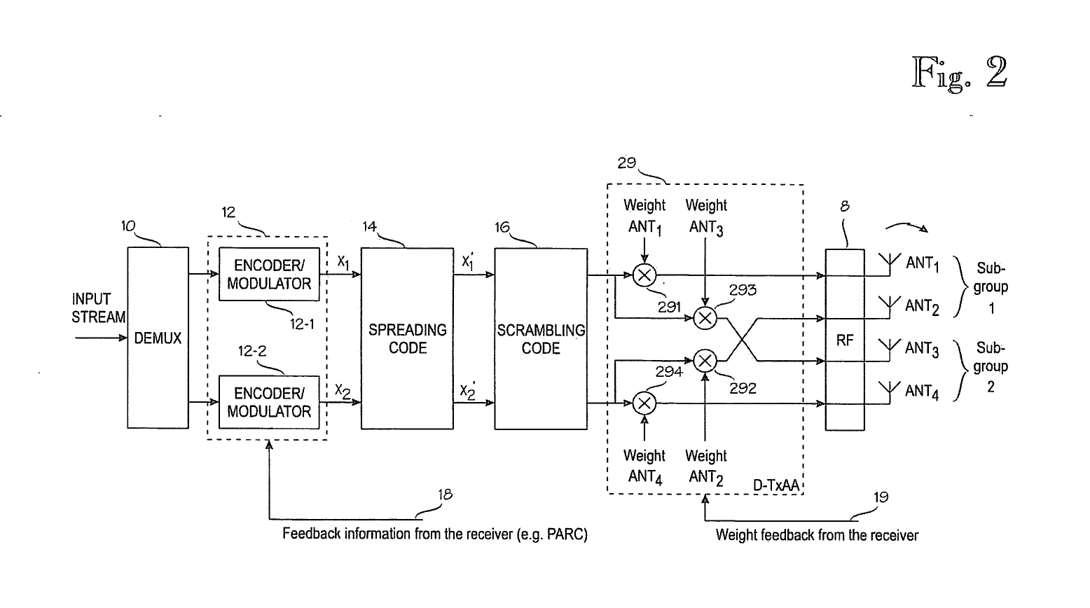

An example of a transmitter employing a multi-stream MIMO with the double-TxAA (D-TxAA) technique is shown in FIG. 2. At the transmitter, the high-speed information stream is first demultiplexed into 2 substreams, each of the substreams being separately encoded and modulated by a respective encoder and modulator block 32-1 . . . 32-Nₜ in the modulator bank 32. In modulation, each data substream is mapped by constellation mapper onto a stream of symbols, such as quadrature phase shift keying (QPSK) and 16-quadrature amplitude modulation (16-QAM). Each of the modulated data streams x₁ . . . x_{Nt} is separately multiplied by the same set of spreading codes in a spreading code block 14. Each modulated data stream x₁ . . . x_{Nt} results in a corresponding set of spread signals which are combined into a respective spread data stream x₁ and x₂. Each of the data streams x₁ and x₂ is separately multiplied by a common scrambling code in a scrambling code block 15. Up to this point, the transmitter of FIG. 2 may be similar to that of FIG. 1. However, in D-TxAA block 29, four transmit antennas ANT₁ . . . ANT₄ are employed in the transmitter to transmit the two substreams x₁ and x₂. The four transmit antennas ANT₁ . . . ANT₄ are divided into two sub-groups 1 and 2 and each subgroup transmits independent data stream with TxAA (Transmit Antenna Array) operation of a pair of transmit antennas ANT₁/ANT₂ and ANT₃/ANT₄. In TxAA operation the signals for each antenna in the pair are weighted, in multipliers 291-294 by a complex amplitude matched chosen to best match to the instantaneous channel characteristics, prior to applying the signals to the antennas through the RF transmitter section 8. For spatial multiplexing, the weight vectors for different antenna pairs (i.e. for different substreams), i.e. Weight ANT₁ and Weight ANT₂ for the antenna pair ANT₁/ANT₂ and Weight ANT₃ and Weight ANT₄ for the antenna pair ANT₃/ANT₄, are mutually orthogonal. The D-TxAA can seen as twofold Transmit Diversity chain. Each chain may be controlled similar to the PARC depending on the channel. In other words, the data rates for each antenna are controlled by adaptively allocating transmit resources such as modulation order, code rate, and number of spreading codes based on feedback information obtained from a receiver. D-TxAA requires an additional feedback from the receiver to indicate which weighting vector(s) to use. The receiver for for D-TxAA technique may, for example, basically be similar to that shown in FIG. 1 with the additional feedback indicating the weighting vector(s

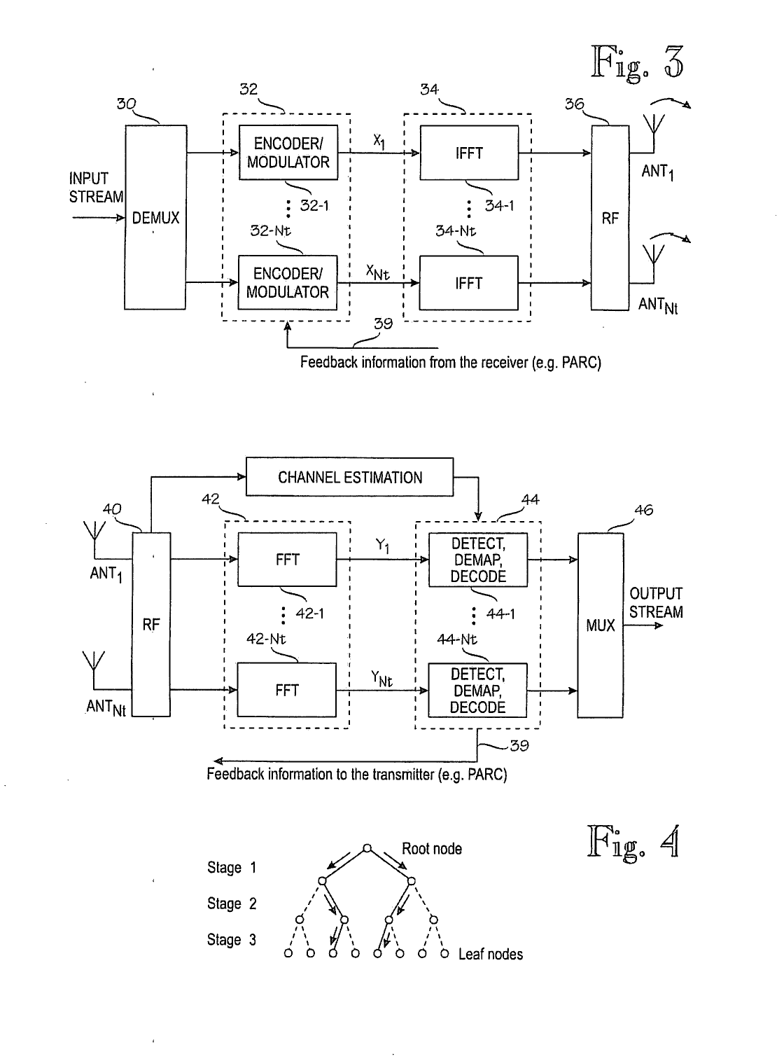

A MIMO-OFDM system model with Nₜ transmit and Nᵣ receive antennas is shown in FIG. 3. The input high-speed data stream is serial-to-parallel converted into Nₜ parallel data substreams by a demultiplexer block 30. In a modulator bank 32, each data substream is encoded and mapped by a respective encoder and modulator block 32-1 . . . 32-Nₜ onto a stream of symbols, such as binary phase shift keying (BPSK), quadrature phase shift keying (QPSK), 16-quadrature amplitude modulation (16-QAM), or 64-QAM modulation symbols. After the modulation, each of streams x₁ . . . x_{Nt} is inputted to a corresponding inverse Fast Fourier transform (IFFT) block 34-1 . . . 34-Nₜ which treats the input source symbols (e.g. QPSK or QAM) as though they are in the frequency-domain and converts them into the time-domain. The IFFT block 34 takes in Nₜ symbols at time. Each of these Nₜ symbols acts like a complex weight for the corresponding sinusoidal basis function. Since the input symbols are complex, the value of the symbol determines the both the amplitude and phase of the sinusoid for that sinusoid. Thus, the IFFT provides a simple way to modulate data on to a number of orthogonal subcarriers. The data rates for each transmit antenna ANT₁ . . . ANT_{Nt} may be individually controlled by adaptively allocating transmit resources such as modulation order and code rate based on feedback information 39 obtained from a receiver in a manner similar to PARC. In the time-domain signal that results from the IFFT bank 34, a cyclic prefix is inserted in front of each OFDM symbol as a guard interval. The cyclic prefix consists of the end of the OFDM symbol copied into the guard interval. The reason that the guard interval consists of a copy of the end of the OFDM symbol is so that the receiver will integrate over an integer number of sinusoid cycles for each of the multipaths when it performs OFDM demodulation with the FFT. The resulting substreams are converted to the subcarrier frequencies in the RF transmitter section 36 and transmitted through different transmit antennas ANT₁ . . . ANT_{Nt} over the radio path to the receiver. At the receiver, the signals received by the receive antennas ANT₁ . . . ANT_{Nr} are converted to baseband or intermediate frequency (IF) signals in the RF receiver section 40 and inputted to the FFT bank 42. The FFT blocks 42-1 . . . 42_{Nt} convert the time-domain signals into the frequency-domain symbol streams y₁ . . . y_{Nt} which are inputted to a detector bank 44. A channel estimation block 48 provides a channel response estimation (e.g. estimated channel coefficients) for each of the received signals and provides the channel estimates to the detector bank 44. The goal of the the detection/demapping/decoding blocks 44-1 . . . 44-Nₜ is to detect the symbols effectively from the received signal and the estimated channel responses. The receiver may also provide feedback information 19 to the transmitter so that the transmitter can adjust data rate at each antenna independently based on the feedback information. For example, the post-decoding SINR of each transmit antenna is estimated at the receiver and then fed back to the transmitter.

The principles of the present invention can be applied in the detector banks 26 and 34 of the receivers shown in the FIGS. 1 and 3, for example, to detect multi-stream MIMO communication. It should be appreciated that the invention is primarily focused on a novel pre-ordering of the MIMO streams prior to the QRD-M algorithm in the detector so that the configuration of other parts of receiver or the configuration of the transmitter are not essential to the basic invention. The preordering algorithm is universally applicable to any QRD-M based detector in a multi-stream MIMO receiver.

Let us know study the theory of the MIMO-OFDM system shown in FIG. 3 wherein the signals transmitted from the Nₜ transmit antennas are received by the Nᵣ receive antennas (Nₜ<Nᵣ). Assuming perfect timing and frequency synchronization, the received signal at each sub-carrier can be formulated as

y=Hx+n (2.1)

Where y and n are the Nᵣ -size received signal vector and the additive white Gaussian noise (AWGN) vector with power σ², respectively. x denotes the Nₜ-size the transmitted signal vector. H denotes MIMO channel matrix, defined in (2.2).

$$H = {[ \begin{matrix}{h}_{0 , 0} & {h}_{0 , 1} & ⋯ & {h}_{0 , {N}_{t} - 1} \\ {h}_{1 , 0} & ⋯ & ⋯ & ⋯ \\ ⋯ & ⋯ & ⋯ & ⋯ \\ {h}_{{N}_{r} - 1 , 0} & ⋯ & ⋯ & {h}_{{N}_{r} - 1 , {N}_{t} - 1}\end{matrix} ]}_{{N}_{r} , {N}_{t}} \qquad ( 2.2 )$$

Let us now examine the use of the conventional maximum likelihood signal detecting (MLSD) and QR Decomposition-M (QRD-M) algorithms for detecting the signals according to equation (2.2.).

With multi-stream interference (MSI) due to the signals from the different transmit antennas on the same sub-carrier and interfering each other, MLSD is the optimal receiver to minimize the error probability. MLSD performs vector decoding in accordance with equation (3.1).

$$\hat{x} = {arg min}_{x} \{ {‖ y - Hx ‖}^{2} \} \qquad ( 3.1 )$$

Where the minimization is performed by searching all the possible constellation points in x. It can be noticed that MLSD has complexity exponential to the number of Tx antennas and modulation alphabets.

QR-decomposition based M-searching is a near-optimal scheme to achieve a good tradeoff between the system complexity and performance. The QR decomposition can be applied to the channel matrix H at each sub-carrier as

H=QR (3.2)

Where Q is a Nᵣ by Nᵣ sized unitary matrix and R is Nᵣ by Nₜ sized matrix

$$R = {[ \begin{matrix}T \\ {0}_{{N}_{r} - {N}_{t} , {N}_{t}}\end{matrix} ]}_{{N}_{r} , {N}_{t}} \qquad ( 3.3 )$$

Where T is a Nₜ by Nₜ up-triangle matrix.

Multiplying (2.1) with Q* from left side (* denoting the conjugation transposition) and using both (3.2) and (3.3), (3.4) can be obtained.

$$y = QRx + n \\ {Q}^{*} y = {Q}^{*} QRx + {Q}^{*} n \\ [ \begin{matrix}{\tilde{y}}_{u} \\ {\tilde{y}}_{d}\end{matrix} ] = [ \begin{matrix}T \\ 0\end{matrix} ] x + [ \begin{matrix}{\tilde{n}}_{u} \\ {\tilde{n}}_{d}\end{matrix} ] \qquad ( 3.4 )$$

Ignoring the bottom part of (3.4), we obtain

\tilde{y}ᵤ=Tx+ñᵤ (3.5)

Because T is an up-triangle matrix, the MLSD algorithm is exactly equivalent to a tree searching problem to find the leaf note holding the minimum metric as

$$\hat{x} = {arg min}_{x ∈ Φ} \{ {‖ {\tilde{y}}_{u} - Tx ‖}^{2} \} \qquad ( 3.6 )$$

Where Φ is the set including all possible values of x. Based on the breadth-first tree searching algorithm, QRD-M is proposed in paper [2] and [5]. It reduces system complexities, as opposed to MLSD algorithm, by keeping only a fixed number of candidates with the smallest accumulated metrics at each stage of the tree searching. Conclusively, the QRD-M searching algorithm can be summarized as follows:
1) Perform QR decomposition on H
2) Use Q* multiplying y from left side
3) Extend the reserved branches to next stage
4) Calculate all branch metrics extended from the survive branches
5) Select M branches with the lest metrics as survivor
6) Go to step 3) until the final stage has been reached.
7) Select the branch with the lest metrics as output

FIG. 4 illustrates a 3-stage QRD-M searching example with M=2, where the solid line denotes the survive branch, and the dash line denotes the non-survive branch.

In practice, the pre-ordering before QR-decomposition has great impacts on QRD-M performance. There exist two well-known signal pre-ordering methods named H-norm ordering in paper [4] and H-inverse ordering in paper [2]. H-norm ordering is based on the column norms of the channel matrix H, in the other word the channel gain of the signal elements, while H-inverse ordering is done based on the row norm of the pseudo inverse of the channel matrix, i.e. H*. It is noticed that H-inverse has more complexities than H-norm due to its pseudo inverse operation.

Because the H-inverse signal pre-ordering has the similar progress as that of H-norm, for simplicity of expression we only present the H-norm signal ordering progress in this report. At first, we will rewrite (2.1) into

$$y = Hx + n = [ \begin{matrix}h ( 0 ) & h ( 1 ) & ⋯ & h ( {N}_{t} - 1 )\end{matrix} ] [ \begin{matrix}x ( 0 ) \\ x ( 1 ) \\ ⋮ \\ x ( {N}_{t} - 1 )\end{matrix} ] + n \qquad \qquad ( 3.7 )$$

Where h(i) denotes the i-th column vector of matrix H and x(i) denotes the i-th element in signal vector x. By defining (3.8),

E(i)=∥h(i)∥² (3.8)

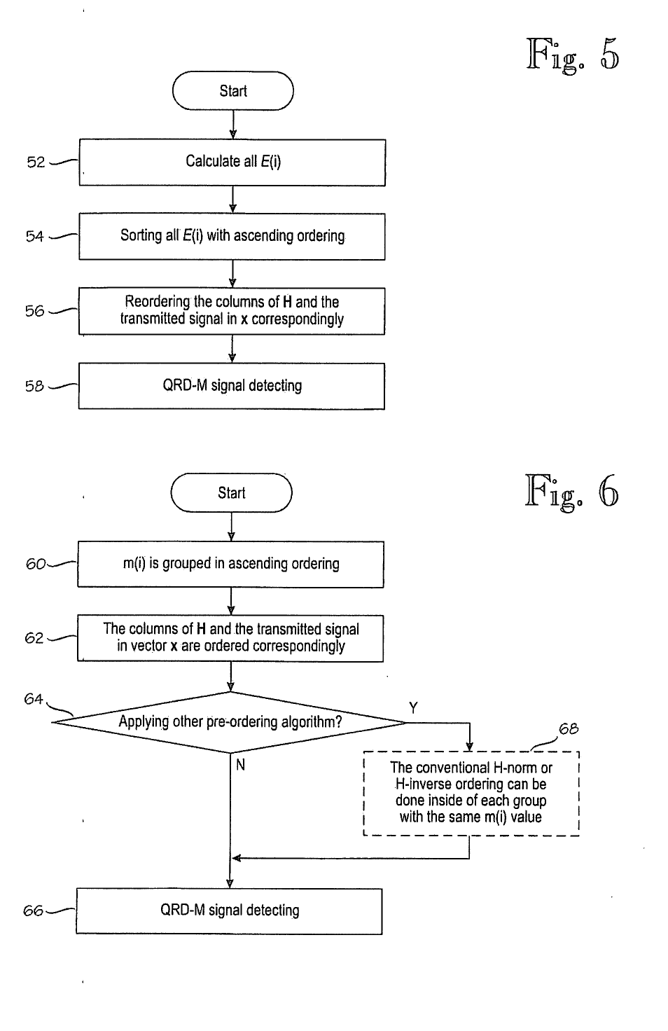

the flowchart of the H-norm signal ordering can be implemented as illustrated in FIG. 5. In step 52, E(i) values are calculated for all columns h(i) of the matrix H according to equation (3.8). In step 54, all E(i) values are sorted with ascending ordering, i.e. sorted in order from the smallest value to the largest value. In step 56, the columns h(i) of matrix H and the transmitted signal x are reordered according to the ascending order of their E(i) values. In step 58, the QRD-M signal detection is performed on the reordered matrix H.

### Example of an Ordered QRD-M Algorithm According to the Invention

According to the present invention, the performance of QRD-M detection, particularly the bit error performance, can be improved by a novel sorting the detection order based on modulation alphabets at different antennas in a multi-stream MIMO in which in modulation of the streams can be varied independently. Suitable multi-stream MIMO system include, for example, per-antenna rate control (PARC) and D-TxAA described above. An example embodiment of the invention is illustrated by a flowchart shown in FIG. 6.

Let us first explain the meaning of the term modulation alphabet as used herein. In digital modulation, an analog carrier signal is modulated by a digital bit stream. This can be described as a form of digital-to-analog conversion. The changes in the carrier signal are chosen from a finite number of alternative symbols, i.e. the modulation alphabet. Examples of the basic digital modulation techniques include a quadrature phase-shift keying (QPSK) and a quadrature-amplitude modulation (QAM). In the QPSK, an inphase signal (the I signal, for example a cosine waveform) and a quadrature phase signal (the P signal, for example a sine wave) are phase modulated with 4 phases, e.g. 0, +90, +180 ja +270 astetta, and the modulation alphabet consists of 4 symbols each representing 2 bits (00, 01, 10, 11). In 8-PSK, 8 modulation phases are employed to form a modulation alphabet of 8 symbols each representing 3 bits (000, 001, 010, 011, 100, 101, 110, 111). In the QAM, an inphase signal (the I signal, for example a cosine waveform) and a quadrature phase signal (the Q signal, for example a sine wave) are amplitude modulated with a finite number of amplitudes. The resulting signal is a combination of a finite number of at least two phases, and a finite number of at least two amplitudes. Each of these phases or amplitudes are assigned a unique pattern of binary bits. Usually, each phase or amplitude encodes an equal number of bits. This number of bits comprises the symbol that is represented by the particular phase. Generally, If the alphabet consists of M=2^{N} alternative symbols, each symbol represents a message consisting of N bits. For example in 16QAM, the modulation alphabet consists of 16 alternative symbols, each symbol representing 4 bits. In the case of QPSK and QAM, the modulation alphabet is often conveniently represented on a constellation diagram, showing the amplitude of the I signal at the x-axis, and the amplitude of the Q signal at the y-axis, for each symbol.

In equation (3.7), x(i) denotes the i-th element of the signal vector x. In an embodiment of the invention, we further define m(i) which denotes the modulation order of the i-th element of the signal vector x. For example, if x(i) is QPSK modulated, then m(i) equals to 4, and if x(i) is 16QAM modulated, m(i) equals to 16, and so on.

Referring now to FIG. 6, in contrast to the conventional H-norm signal ordering which sorts over all E(i), the ordering algorithm according an example embodiment first of all classify m(i) into several groups gₘ₍ᵢ₎ based on the corresponding modulation alphabet at each stream in step 60. The m(i) values may be grouped in descending order, i.e. in order from the highest m(i) value (e.g. 16) to the lowest m(i) value (e.g. 4). In step 62, the columns h(i) of matrix H and the transmitted signal x are reordered according to the descending order of their respective m(i) values. In the optional step 64 it is checked whether any other preordering algorithm is to be applied to the groups. If no other preordering algorithm is applied, the process proceeds to step 66, in which the QRD-M signal detection is performed on the reordered matrix H obtained in step 62. However, if another preordering algorithm is applied, the process proceeds to step 68. In step 68, the symbols within each group having the same m(i) value may further be sorted based on E(i) values similarly as described above relating to FIG. 5.

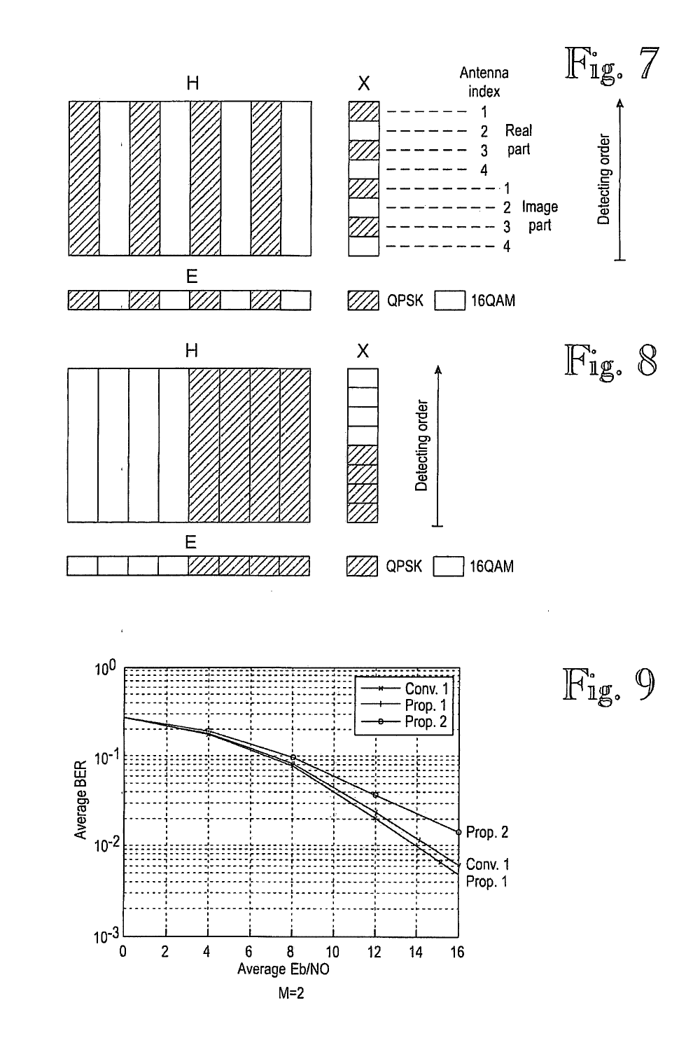

FIGS. 7 and 8 illustrate graphically the effect of the pre-ordering algorithm in an example embodiment wherein it is applied in a 4×4 MIMO system, i.e. in a system having 4 transmit antennas and 4 receive antennas. In this example, we assume the signals in the first and third transmit antennas are QPSK modulated and the signals in the second and the fourth transmit antennas are 16QAM modulated. After converting the complex matrix form to the real matrix form, the initial order of the original transmitted signal vector x, the channel matrix H and the channel gain E is as illustrated in FIG. 7. The gray and white blocks in vector x denote the signals modulated by QPSK and 16QAM respectively. Similarly, the channel response in channel matrix H and its channel gain E(i) related to each transmitted signal x are denoted with the same color. The detecting order is from bottom to top in the example of FIG. 7. After preordering according to the present invention based on modulation alphabet where the transmitted signals were divided into two groups, QPSK and 16QAM modulated streams, the corresponding channel matrix H and its gain E(i) can be pre-ordered in the manner shown the FIG. 8. Now the QRD-M signal detection is performed first to the group of the 16QAM modulated signals and then to the group of the QPSK modulated signals. Optionally, the conventional H-norm or H-inverse signal pre-ordering algorithm may additionally be done in each group independently, if desired, prior to the QRD-M signal detection, so as to order the signals having same m(i) according to their channel gain E(i) values.

The conventional QRD-M signal detection and the ordered QRD-M signal detection according to the present invention were our proposed schemes are analyzed by numerical simulations. The simulation specifications are summarized in Table 1.

TABLE 1
Simulation specifications

| | |
|---|---|
| Systems | MIMO-OFDM 4 × 4 antennas |
| | Conv. The QRD-M without signal pre-ordering |
| | Prop.1 The QRD-M with proposed signal |
| | pre-ordering, without sorting |
| | inside subgroup |
| | Prop.2 The QRD-M with the inverse signal |
| | pre-ordering without sorting |
| | inside subgroup |
| Sampling Rate | 5 M |
| Block Size | 256 Symbols |
| CP Size | 32 symbols |
| Carrier Frequency | 2.3 G Hz |
| Modulation | QPSK and 16QAM adaptive employed based |
| | on the CQI |
| Channel State | Power Distribution Profile: ITU-VA |
| | Quasi-static in each data block |
| Channel estimation | Perfect |
| Channel feedback | Perfect |
| The number of Survived | 2, 4, 8 |
| branch (M) | |

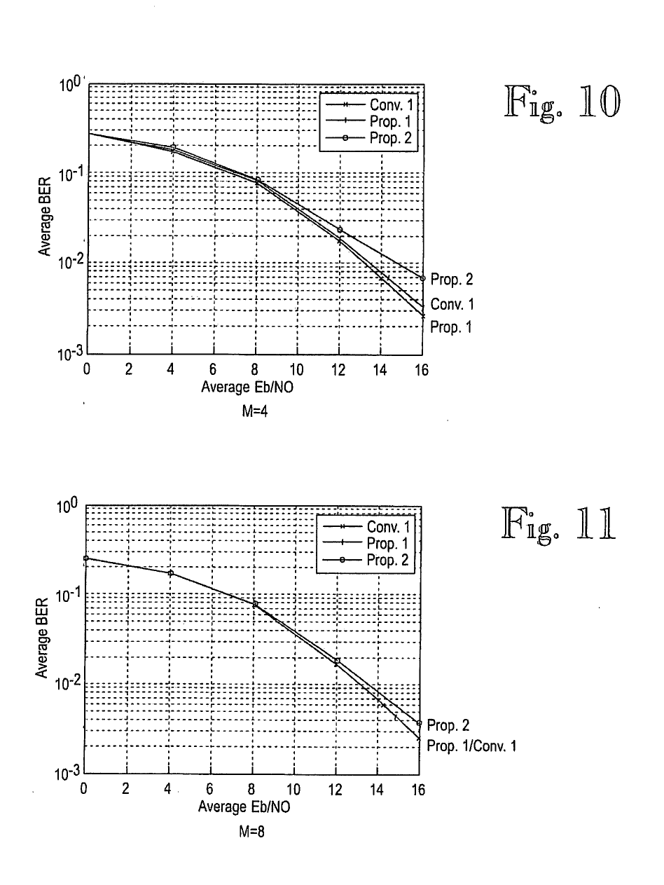

FIGS. 9, 10 and 11 illustrate the numerical results of the alternative schemes. From the comparison between the embodiments of the invention, Prop.1 and Prop.2, it can be noticed that the signal-preordering has great impact on the QRD-M performance. Inverse-ordering as in the second embodiment Prop.2 can even worsen the system performance comparing to the conventional scheme. However, the scheme according to the first embodiment of the invention (Prop.1) can outperform the conventional scheme by approximately 0.7 dB and 0.3 dB for the target 10⁻² BER with M=2 and M=4, respectively. Both embodiments approach the MLSD bound with approximately same performance while M is 8. It should be appreciated that such a performance gain can be reached without any extra cost. With increased number of multistreams in MIMO systems, the more gain can be reached by the scheme of the present invention in comparison with the conventional one.

The techniques described herein may be implemented by various means. For example, these techniques may be implemented in hardware (one or more devices), firmware (one or more devices), software (one or more modules), or combinations thereof. For a hardware implementation, the processing units used for channel estimation may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For a firmware or software, implementation can be through modules (e.g., procedures, functions, and so on) that perform the functions described herein. The software codes may be stored in memory unit and executed by the processors. The memory unit may be implemented within the processor or external to the processor, in which case it can be communicatively coupled to the processor via various means as is known in the art. Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method, comprising:
receiving multiple spatial signal streams from a multiple-input multiple output (MIMO) channel; and
pre-ordering said multiple received spatial signal streams based on modulation alphabets of said received spatial signal streams prior to performing a QR Decomposition-M detection.

2. The method as claimed in claim 1, wherein said pre-ordering comprises:
forming a signal vector from said received spatial signal streams;
estimating a transmission channel matrix for said MIMO channel; and
pre-ordering elements of said signal vector and elements of said transmission channel matrix based on said modulation alphabets of said received spatial signal streams prior to performing said QR Decomposition-M detection.,

3. The method as claimed in claim 1, wherein said pre-ordering comprises:
forming a signal vector from said received spatial signal streams;
estimating a transmission channel matrix for said MIMO channel; and
pre-ordering elements of said signal vector and elements of said transmission channel matrix into groups based on said modulation alphabets of said received spatial signal streams such that each of said group corresponds to different value of said modulation alphabets.

4. The method as claimed in claim 3, comprising:
performing a further preordering within each group of said elements of said signal vector and said elements of said transmission channel matrix prior to performing said QR Decomposition-M detection.

5. The method as claimed in claim 4, wherein said further preordering comprises one of a H-norm ordering and a H-inverse ordering.

6. The method as claimed in claim 1, wherein said receiving comprises receiving 16QAM-modulated spatial signal streams having a modulation alphabet with value 16, and QPSK-modulated spatial signal streams having a modulation alphabet with value 4.

7. The method as claimed claim 1, wherein said receiving comprises receiving multiple spatial signal streams from an orthogonal frequency division multiplexing MIMO channel.

8. The method as claimed in claim 1, wherein said receiving comprises receiving multiple spatial signal streams from one of a transmit antenna array MIMO channel and a double transmit antenna array MIMO channel.

9. The method as claimed in claim 1, wherein said receiving comprises receiving multiple spatial signal streams with independently variable modulation schemes.

10. The method as claimed in claim 1, wherein said receiving comprises receiving multiple spatial signal streams which are rate controlled by a per-antenna rate control.

11. A computer program embodied on a computer readable medium, the computer program comprising program code for controlling a processor to execute a method comprising:
receiving multiple spatial signal streams from a multiple-input multiple output channel; and
pre-ordering said multiple received spatial signal streams based on modulation alphabets of said received spatial signal streams prior to performing a QR Decomposition-M detection.

12. A computer program embodied on a computer readable medium, the computer program comprising:
a component configured to receive multiple spatial signal streams from a multiple-input multiple output channel; and
a component configured pre-order said multiple received spatial signal streams based on modulation alphabets of said received spatial signal streams prior to performing a QR Decomposition-M detection.

13. An apparatus, comprising:
a receiver unit configured to receive multiple spatial signal streams from a multiple-input multiple output (MIMO) channel; and
a signal processing unit configured to pre-order said multiple received spatial signal streams based on modulation alphabets of said received spatial signal streams prior to performing a QR Decomposition-M detection.

14. The apparatus as claimed in claim 13, wherein said signal processing unit is configured to pre-order elements of a signal vector formed from said received spatial signal streams, and elements of an estimated transmission channel matrix of said MIMO channel, based on said modulation alphabets of said received spatial signal streams prior to performing said QR Decomposition-M detection.

15. An apparatus as claimed in claim 13, wherein said signal processing unit is configured to pre-order elements of a signal vector formed from said received spatial signal streams, and elements of an estimated transmission channel matrix of said MIMO channel, into groups based on said modulation alphabets of said received spatial signal streams such that each of said group corresponds to different value of said modulation alphabets.

16. The apparatus as claimed in claim 15, wherein said signal processing unit is configured to perform a further preordering within each group of said elements of said signal vector and said elements of said transmission channel matrix prior to performing said QR Decomposition-M detection.

17. The apparatus as claimed in claim 16, wherein, wherein said signal processing unit is configured to perform said further pre-ordering using one of a H-norm ordering and a H-inverse ordering.

18. The apparatus as claimed in claim 13, wherein said receiver unit is a receiver unit configured to receive 16QAM-modulated spatial signal streams having a modulation alphabet with value 16, and QPSK-modulated spatial signal streams having a modulation alphabet with value 4.

19. The apparatus as claimed in claim 13, wherein said receiver unit is configured to receive multiple spatial signal streams from an orthogonal frequency division multiplexing (OFDM) MIMO channel.

20. The apparatus as claimed in claim 13, wherein said receiver unit is a receiver unit configured to receive multiple spatial signal streams from one of a transmit antenna array) MIMO channel and a double transmit antenna array MIMO channel.

21. The apparatus as claimed in claim 13, wherein said receiver unit is a receiver unit configured to receive multiple spatial signal streams with independently variable modulation schemes.

22. The apparatus as claimed in claim 13, wherein said receiver unit is a receiver unit configured to receive multiple spatial signal streams which are rate controlled by a per-antenna rate control.

23. The apparatus as claimed in claim 13, wherein at said receiver unit and said signal processing unit are implemented in hardware, firmware, software, or combinations thereof.

24. The apparatus as claimed in claim 13, wherein said apparatus is implemented in a wireless base station.

25. A wireless mobile terminal comprising:
an apparatus comprising a receiver unit configured to receive multiple spatial signal streams from a multiple-input multiple output (MIMO) channel and a signal processing unit configured to pre-order said multiple received spatial signal streams based on modulation alphabets of said received spatial signal streams prior to performing a QR Decomposition-M detection.

26. A wireless base transceiver comprising:
an apparatus comprising a receiver unit configured to receive multiple spatial signal streams from a multiple-input multiple output (MIMO) channel and a signal processing unit configured to pre-order said multiple received spatial signal streams based on modulation alphabets of said received spatial signal streams prior to performing a QR Decomposition-M detection.
